(19) United States
(12) Patent Application Publication
(10) Pub. No.: US 2004/0225561 A1
(43) Pub. Date: Nov. 11, 2004

(54) Method for handling a subscription of a communication device

(76) Inventors: Todd Hertzberg, Denedin, FL (US); Povl Koch, Copenhagen (DK)

Correspondence Address: PERMAN & GREEN, LLP, 425 Post Road, Fairfield, CT, 06824, US

(21) Appl. No.: 10/434,814

(22) Filed: May 9, 2003

(51) Int. Cl. G06F 17/60

(52) U.S. Cl. 705/14

(57) ABSTRACT

A business method for handling subscription of a communication device for a user and being sponsored by a sponsor includes agreeing to provide subscription for said communication device with the sponsor; handing over said communication device associated with the subscription to the sponsor; allowing the sponsor to define a finite set of phone numbers being allowed for communication with said communication device; allowing the sponsor to associate said finite set of phone numbers with respective key inputs of said communication device; allowing the sponsor to hand over said communication device to the user; and handling the billing of the subscription with the sponsor.

### BACKGROUND OF THE INVENTION

1. Field of the Invention

The invention relates to a method for providing a communication link between a manager an at least one other person moving around.

2. Brief Description of Related Developments

U.S. Pat. No. 5,200,995 describe how to prevents a telephone or a plurality of telephones from making unauthorized or restricted calls to specific numbers or unspecific groups of numbers. The restricted call numbers may be local or toll call. Entering a user defined pass code disables the circuit either on a call-by-call basis, or indefinitely.

### SUMMARY OF THE INVENTION

According to a first aspect of the invention there is provided a business method for handling subscription of a communication device for a user and being sponsored by a sponsor, comprising the steps of agreeing a subscription for said communication device with the sponsor; handing over said communication device associated with the subscription to the sponsor; allowing the sponsor to define a finite set of phone numbers being allowed for communication with said communication device; allowing the sponsor to associate said finite set of phone numbers with respective key inputs of said communication device; allowing the sponsor to hand over said communication device to the user; and handling the billing of the subscription with the sponsor.

The consumers would buy this device due to different reasons, such as ready-to-use. The consumer may stay connected and receive calls anywhere.

For one of the embodiments, there is no contract raising monthly bills or pre-paid card needed to receive calls. In addition to this the user is free to requests calls by pressing a “Call Me” button.

Mobile operators would also benefit a lot by promoting this concept along with a service package:

Low cost terminal with no or less need for subsidies.

Increases in interconnect fees; everybody can call these device owners.

Less churn and lower distribution costs.

Fewer call attempts—reduced by “Call Me” buttons.

Possibility to bundle with regular handsets with special rate plan and/or sales package.

Low risk of cannibalization of existing users due to the clearly differentiated service/product offering.

### BRIEF DESCRIPTION OF THE DRAWINGS

The features, objects, and advantages of the invention will become more apparent from the detailed description set forth below when taken in conjunction with the drawings in which like reference characters identify correspondingly throughout and wherein:

FIG. 1 schematically illustrates a preferred embodiment of a communication device for use in a method according to the invention.

FIG. 2 schematically shows the essential parts of a communication device for communication with e.g. a cellular network.

### DETAILED DESCRIPTION OF THE INVENTION

Referring to the figures referred in exemplary embodiments of the invention above-described, the exemplary embodiments will be described with reference to a particular method for use handling a subscription for a mobile telephone but principles of the invention are applicable to other subscription method including wireless communication devices.

According to the preferred embodiment of the invention, there is provided a business method for handling subscription of a communication device for a user and being sponsored by a sponsor. The method according to the invention may find use in geographical areas where the cellular penetration is low and where the cellular communication still is a privileged to the most wealthy part of the population, and where an employer wants to be in touch with his employees, e.g. within transport business or service business. By implementing the invention the employer or sponsor may give a communication terminal to some or all his employees. Thereby able to get in contact with the employees he wants to when a need occurs.

As an additional group to the employees, the businessman may give a communication terminal to his key customers, so they easily can place orders for fast execution.

The benefit for the sponsor is that he will be able to restrict the cost for the entire fleet of communication terminals he sponsors by restricting the communication to what he feels as being necessary as sponsor. For the sponsor this means a low cost investment, with a significant reduction of un-expected later cost (cost control), but still having an opportunity to communicate with employees, and to control resource allocation and employees.

Another sponsor who may benefit from the invention may be a man having an house with several members—of course including the family members, such as children and elderly, but also nannies, maids, and drivers.

Still another group of users could be hotel guests. The concept may be used for communication devices used as call-back pagers, as telemarketing devices, Tourists-info services (Rent a device—only temporary usage).

The benefit for the users or the employees will be that they will be able to get guidance, security, help or status update. The user will have some restrictions in out going calls, but he may still receive calls from anybody.

The sponsor has to agree a subscription for the communication device with a cellular network operator. This subscription may include that the cellular network operator subsidizes the communication device when the sponsor buys the communication device as a part of the subscription. This subsidizing may be regarded by the cellular network operator as an investment for getting increased airtime traffic in the cellular network.

However the sponsor may acquire the communication device from a second source if he finds this appropriate. The communication device has just to fulfil the requirements of the requirements of the network of the cellular network operator—e.g. TDMA or CDMA type network.

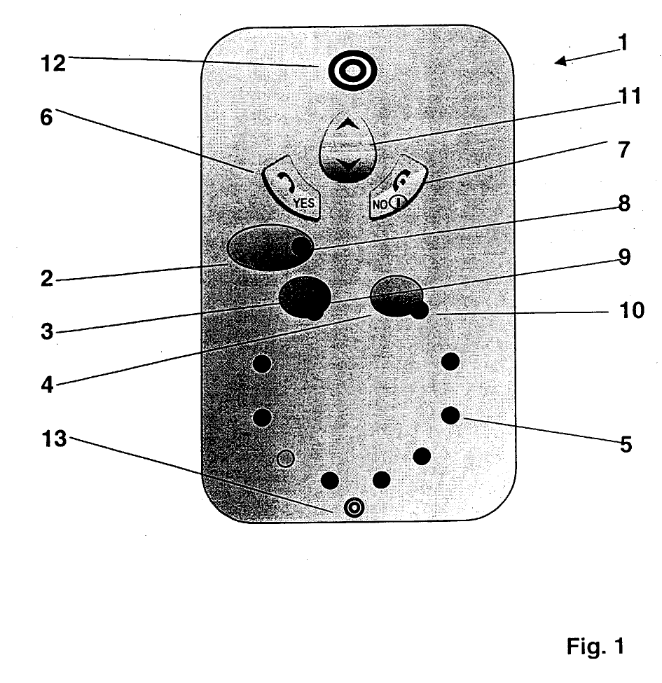

When the sponsor receives the communication device he has to prepare the communication device before handing it out to the user. The preferred embodiment of the communication device 1 for be used with the method according to the invention is shown in FIG. 1. The device 1 has neither an alphanumeric keypad nor a graphic display, but it may still be possible with some complex voice or keypad based solutions to enter the finite set of phone numbers manually.

However, the preferred input method for the finite set of phone numbers will be to define them with the SIM Card inserted to another handset having a full User Interface with display and alphanumeric keys, e.g. Nokia 6310™—by e.g. defining special numbers to the phone book which are then auto-fetched when SIM card is inserted to the communication device 1. This may be done for GSM and WCDMA telephones.

As an alternative to this, “pre-defined” numbers for the three speed dial keys 2,3 and 4 (including a Master-key 2) according to the embodiment shown in FIG. 1 could be used, and these “pre-defined” are then mapped in the network. Yet an alternative could be a sort of “Over The Air” (OTA) set-up, e.g. based sending “smart” messages (Nokia Smart Messaging concept) from another “normal” handset to the communication device 1, which changes the speed dial assignments upon approval of the user or the sponsor.

According to the basic User Interface for the communication device 1, all main functionalities should be obtained using the keypad and the LED's 5. Any incoming calls can be answered by pressing Send-key 6. If the incoming call is from one of the three favourites, the call can also be answered by pressing the corresponding speed dial key, e.g. the Master-key 2.

An incoming call is indicated by playing ringing tone, and preferably there will be a distinct tone for each of the three speed dial number plus a “general” one (for all other) (four in total). The incoming call may also indicated with heavy flashing of all the LED's 5—or by a running flashing pattern. This is to assure indication also when ringing is set to silent. In case a call is received from one of the three speed dial number (this requires Calling Line Identification (CLI) support), the corresponding LED 8, 9, and 10 for that speed dial number is also lit or flashing.

Pressing an END-key 7 can reject any Incoming call. For adjusting ringing volume during incoming calls, the preferred method will be simply pressing scroll-keys 11 up/down during an incoming call—scrolling down decreases level, and scrolling up increases. The level will be marked by a number of adjacent LCDs lit. Level 0 means silent. This ringing volume setting will be stored and used for all future calls or until ringing volume is adjusted again.

The embodiment of communication device 1 shown in FIG. 1 supports calling up to eleven speed dials in total. These are divided as follows:

One primary speed-dial key 2 (the Master key);

Two secondary speed dial keys 3 and 4;

Eight additional speed dials—the user first presses the Send-key 6. This will light up the first LED in the LED line 5. The user selects the desired memory position by scrolling with the scroll key 11 until the desired memory position is indicated with the associated LED, and finally called by pressing the call key 6 once more.

There may preferably be a timeout in this mode where after the LED's and thereby the alternative speed dial selection is switched off again.

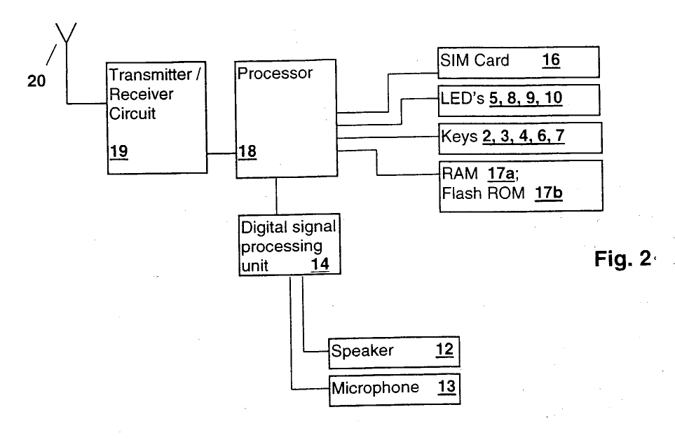

FIG. 2 schematically shows the most important parts of a preferred embodiment of the phone, said parts being essential to the understanding of the invention. A processor 18, which supports the GSM terminal software, also controls the communication with the network via the transmitter/receiver circuit 19 and an antenna 20.

The microphone 13 transforms the speech of the user into analogue signals; the signals formed thereby are A/D converted in an A/D converter (not shown) before the speech is encoded in an audio part that includes a digital signal processor unit 14. The encoded speech signal is transferred to the processor 18. The processor 18 also forms the interface to a RAM memory 17a and a Flash ROM memory 17b, a SIM card 16, the LED's 5, 8, 9, and 10 and the keys 2, 3, 4, 6, 7. The audio part 14 speech-decodes the signal, which is transferred from the processor 18 to the speaker 12 via a D/A converter (not shown).

In a further way of carrying out the method according the invention, a “Call me message” is associated with the three keys 2, 3, and 4. Instead of making a speed call to the designated phone number, the communication device in this embodiment sends a predefined message phone number to the phone number associated with the key 2, 3, and 4.

A ‘Call Me’ message is a (pre-defined) short message that indicates to another person that the user of the communication devise 1 wants to be called up. The communication devise 1 has the ability to easily send “Call me message” to the favourites available on the key 2, 3, and 4.

There is no contract raising monthly bills or pre-paid card needed to receive calls. In addition to this the user is free to requests calls by pressing a “Call Me” button. The operator may have a benefit in allowing these free messages because the message itself generates traffic on the network when the receiver of the message calls back.

To send a “Call Me message” to one of the Favourites, the user simply long-presses the corresponding Favourite keys 2, 3, and 4. In one embodiment it may not be possible to send “Call Me messages” to ‘any’ number, I.e. the user may only send “Call Me messages” to the Favourites. Preferably sending a “Call Me message” is assumed to be done with normal short messages according to e.g. the GSM specification, and hence it may be advisable for the operator to provide a subscription with Flat SMS fee for using this service.

Assignment of the numbers to the Favourite keys 2, 3, and 4 is not straightforward for the communication device 1, and there will be several ways to do this to make it somewhat feasible:

The preferred method will be auto-assigned from the first three record entries from SIM card memory; this allows setting up the numbers in a normal phone, or by a dealer or operator. When the SIM card is inserted. If FDN (Fixed Dialing Numbers for speed dial) is active, the first three FDN numbers should be used.

By using SIM Toolkit data download; the operator (or the user through a WEB page) may also be able to change the speed dial assignments over the air.

However, according to this embodiment, it is also possible to define the number by very-long-pressing (e.g. for more than three seconds) a relevant Favourite key and then using any of a manual voice or keypad driven number input method.

A yet further preferred method includes using a special smart message/business card format for transfer over the air. However this will still require that the user knows which number is received (e.g. number-to-voice with LED's), and it will also require the user to assign/accept the new favourite. As an alternative to this a Calling Line Identification based number transfer method could be used. When user receives a call (with CLI), a very easy way to assign the number from the last received call is offered to store the number to any of the favourites; e.g. by very-long-pressing the corresponding key.

Preferably, the communication device includes an additional feature, allowing the user could to assign a “Voice tag” for each of the speed dial keys. This could be used to give spoken feedback to the user when he is calling the speed dial numbers. When the user then presses any of the speed dial keys, the user will immediately hear in the earpiece the recorded “name” for the person.

Free Communication Terminal Sponsored by the Network Operator.

In telecom environments wherein incoming calls are free on mobile phones—like Calling Party Pays environment, it is possible to give a mobile communication device to consumers, that has a phone number and has the ability to receive unlimited two-way real time voice calls with limited service costs to the consumer. The consumer gains an identity in the world by being now reachable and staying connected with those who matter.

Even in non-“Calling Party Pays” environment, it's possible to put the same device in the hands of consumers (although with a service package available from the mobile carrier) which has a phone number and has the ability to receive and make unlimited two-way real time voice calls to a few numbers, thus placing a restricted burden on the buyer or the payer of the bills.

Many macro factors will support the market demand for these communication devices:

1. Inherent value in having a phone number for those who have no phone at all

2. Inherent value of being accessible while away from home or work even if (and maybe especially if) there is a fixed landline in the home.

3. The extremely high cost of prepaid minutes and low ARPU of prepaid users indicate that on most days the prepaid user is carrying his/her phone on their belt as a “call me if you want to” phone anyways (average usage of call origination by prepaid users—less than one minute per day).

4. The current high usage pattern of mobiles for signalling purposes (call “intents” are quite a high percentage as of all call originations —i.e. ring twice and hang up).

The device has a pre-defined and limited amount of numbers. A first user can press one of the favourites keys 2, 3, or 4 on the communication device 1. Now there could be a few options:

Either a message goes to second user indicating that the first user is trying to reach the second user. Then the second user can call back the first user.

Or a live call is established between the first and the second user.

In a “Calling Party Pays” environment, the user can buy the device and distribute the number to others. This way the user can be reached by different people and still keep a limit on his/her communication costs. The mobile operator here earns revenue from the inter-connect revenues and also by charging some monthly fees for allowing the user to retain the number.

Or in a non-“Calling Party Pays” environment, the user could make outgoing calls in a limited group and the buyer could set the limit by pre-feeding these numbers through different methods into the mobile device. This way, the buyer ensures that s/he can keep in touch with the user and at the same time the buyer (the payer of the bills) keeps a tab on the communication costs.

There is no limitation on the way these mobile calls or The “Call Back Message” could be initiated. It could be by pressing some buttons on the device or by saying the numbers through voice feed or even through ‘touch pad stroke input’ where the user just signals the shape of the number over the device and the device understand the number to be called.

Buyer and User Scenario

Buyer

This new mobile communication device 1 has a few keys to allow its user to reach a limited number of (say to take an example—three) different numbers. The buyer may like to buy this mobile device for his/her employees or family members for him/her or for them to keep in touch. The limited numbers that can be called are decided and agreed with the buyer. Because this device can make outgoing calls to limited numbers decided by the buyer, it will be very, very economical to buy and also to pay the monthly bills as the buyer can have control over which numbers can be called.

For example, if the buyer has own business, the buyer may buy it for his employees (workers, drivers, maids, nanny etc.) so they can stay in contact, or with in the family it can be used to keep in touch between family members (e.g. children, spouse or parents).

User

This mobile device will be bought by either the user's employer or one of the main earning family members and given to the user for keeping in touch. Using this mobile device, the user will be able to accept all or limited (predefined numbers) incoming calls but it will allow the user to make outgoing calls to only limited (lets say as an example three) pre-defined phone numbers through the mobile device. These numbers are chosen in agreement with the buyer who gives this mobile device to the user. Alternatively, the device has a “Call Back Message” key 2, 3, and 4 and by pressing one of these keys 2, 3, and 4, a message goes to the user of another communication terminal to call back the message sending communication device.

Dependent Relationship

In a dependent situation, the following could be a buyer-user scenario. A buyer could buy a communication device (with service package from the mobile operator) and give it to a user to call limited and restricted pre-defined numbers for keeping in touch. The user could be a family member like spouse, kids, parents etc.

Alternatively the same buyer could buy such a device and give it to his/her employees who would use it for calling back to the office or even within a closed group. The office could of course reach also reach these employees who could be inside or outside the office location.

The buyer could be in service industry like a hotel, where travellers like tourists could rent the device or even get it free along with the room key and call predefined limited numbers like the hotel numbers, emergency or tourist information etc. IN this example, the tourists/travellers are dependent upon the hotel or other services.

Here the dependence comes from economic, transient location, human relations or even emotional aspects.

Independent Relationship

This mobile device could be bought by a self-employed person, e.g., a taxi-driver, a carpenter, a plumber, and an electrician. The user could then distribute the number to different people and other people can reach him/her. In this case the buyer has an independent entity.

A dependent mobile device (DMD) allows the dependent user to reach the master. It works in closed groups.

An Independent mobile device (IMD) allows the independent user to reach the world by buying the device for him/her-self. It works in normal calling situations.

Thus either a set of the dependent mobile device could be sold tethered to a normal mobile phone or they could be sold independently like an IMD. Even a DMD could be sold independently and tethered to a main phone later on.

To summarize, the buyer could be an individual, a company or even a service-provider. The user could be using the device on a permanent or temporary basis.

These communication or mobile devices do not need to have the same look and feel like that associated with a regular cellular phone. Therefore it could be in a form factor, which is very different from a mobile phone factor, e.g., a wearable around the neck or a tiny device with a wristband. Alternatively, to increase the appeal, it could be combined with other established concepts like a key ring, a necklace, a watch, a radio, a torch, to name a few.

What is claimed is:—

1. A business method for handling a subscription of a communication device for a user and being sponsored by a sponsor, comprising:
agreeing with a cellular network operator to provide a subscription for said communication device with the sponsor;
handing over said communication device associated with the subscription to the sponsor;
allowing the sponsor to define a finite set of phone numbers being allowed for communication with said communication device;
allowing the sponsor to associate said finite set of phone numbers with respective key inputs of said communication device;
allowing the sponsor to hand over said communication device to the user; and
handling the billing of the subscription with the sponsor.

2. The business method of claim 1, wherein the cellular network operator subsidises the communication device when the sponsor buys the communication device as a part of the subscription.

3. The business method of claim 1, wherein the communication device is adapted to two-way communication.

4. The business method of claim 3, wherein the communication device has neither graphical display nor alphanumeric keys for number input.

5. The business method of claim 4, wherein the communication device has at least one speed dial key for calling a predefined phone number when pressed.

6. The business method of claim 5, wherein the predetermined phone number is stored on an exchangeable memory card.

7. The business method of claim 6, wherein the exchangeable memory card is a Subscriber Identity Module (SIM Card).

8. The business method of claim 1, wherein the sponsor distributes the communication device between hotel guests.

9. A business method for handling the lending out of a communication device for a cellular network to a user and being sponsored by a sponsor having a agreed a subscription for said communication device with a cellular network operator, comprising:
defining a finite set of phone numbers being allowed for communication with said communication device;
handing over said communication device associated with the subscription to the user; and
handling the billing of the subscription with the sponsor.

10. The business method of claim 9, wherein the sponsor is allowed to associate said finite set of phone numbers with respective key inputs of said communication device.

11. The business method of claim 9, wherein the sponsor distributes the communication device between hotel guests.

12. The business method of claim 9, wherein the sponsor distributes the communication between tourists for temporary usage as a rent a device service for tourist information.

13. A business method for handling subscription of a wireless communication device for a user, comprising:
agreeing a subscription for said communication device with the user;
handing over said wireless communication device associated with the subscription to the user;
allowing the user to send “Call Me messages” using said wireless communication device to other wireless communication devices inviting them to call said wireless communication device being subject for the subscription.

14. The business method of claim 13, wherein the communication device is adapted to two-ways communication.

15. The business method of claim 13, wherein the communication device has neither graphical display nor alphanumeric keys for number input.

16. The business method of claim 15, wherein the communication device has at least one speed messaging key for sending a call me message to a predetermined phone number when pressed.

17. The business method of claim 16, wherein the predetermined phone number is stored on an exchangeable memory card.

18. The business method of claim 17, wherein the exchangeable memory card is a Subscriber Identity Module (SIM Card).

19. The business method of claim 13, wherein the “Call Me message” has a predefined text identifying the sender and invites the recipient to call back.

20. A method for handling subscription of a communication device for a user and being sponsored by a sponsor, comprising:
agreeing a subscription for said communication device with a cellular network operator;
receiving said communication device associated with the subscription from the cellular network operator;
defining a finite set of phone numbers being allowed for communication with said communication device;
associating said finite set of phone numbers with respective key inputs of said communication device;
handing over said communication device to the user; and
handling the billing of the subscription as a matter between the sponsor and cellular network operator.

21. The method of claim 20, wherein the cellular network operator subsidises the communication device when the sponsor buys the sponsor buys the communication device as a part of the subscription.

22. The method of claim 20, wherein the communication device is adapted to two-ways communication.

23. The method of claim 22, wherein the communication device has neither graphical display nor alphanumeric keys for number input.

24. The method of claim 23, wherein the communication device has at least one speed dial key calling a predefined phone number when pressed.

25. The method of claim 24, wherein the predetermined phone number is stored on an exchangeable memory card.

26. The method of claim 25, wherein the exchangeable memory card is a Subscriber Identity Module (SIM Card).

27. The method of claim 20, wherein the sponsor distributes the communication device between hotel guests.
